(19) United States
(12) Patent Application Publication
(10) Pub. No.: US 2007/0088488 A1
(43) Pub. Date: Apr. 19, 2007

(54) Vehicle safety system

(76) Inventors: Michael J. Reeves, Attalla, AL (US); Scott D. Elliott, Holly Springs, NC (US)

Correspondence Address: COATS & BENNETT, PLLC, 1400 Crescent Green, Suite 300, Cary, NC, 27518, US

(21) Appl. No.: 11/549,315

(22) Filed: Oct. 13, 2006

Related U.S. Application Data
(60) Provisional application No. 60/727,274, filed on Oct. 14, 2005.

(51) Int. Cl. G01M 17/00; G06F 19/00

(52) U.S. Cl. 701/117; 701/35

(57) ABSTRACT

In one or more embodiments, a vehicle safety system includes a processing unit configured for use in a vehicle. The processing unit includes or is associated with one or more vehicle sensors, such as object detection sensors, and one or more cameras. The processing unit processes vehicle sensor signals to detect vehicular events of interest, such as potentially hazardous operating conditions, and in response it selectively activates recording by one of one or more cameras mounted on the vehicle. For example, during lane changing or lane departure events, the processing unit may activate one or more cameras to capture a visual record of objects in the vehicle's vicinity, or may activate recording responsive to object detection, e.g., leading vehicle detection or front, back, side, top object proximities. Further, the processing unit may tailor recording control based on its particular operating mode, or in response to manual input.

### RELATED APPLICATIONS

This application claims priority under 35 U.S.C. 119(e) from the provisional patent application filed on 14 Oct. 2005 and assigned Ser. No. 60/727,274, and which is expressly incorporated in its entirety herein by reference.

### BACKGROUND

The present invention generally relates to the safety and operation of vehicles, such as long-haul trucks, and particularly relates to vehicle safety systems for vehicles.

U.S. Pat. No. 6,606,207, owned in common with the instant application and incorporated in its entirety herein by reference, disclosed the sophisticated deployment and monitoring of vehicle safety sensors. These sensors and their associated system, whether mounted to commercial long-haul trucks or to RVs and the like, provided drivers with critical safety information in the form of visual and/or audible warnings as a function of object proximity and vehicle operating context. Vehicle operating context was expressed in terms of operating mode, such as Lane Changing, Stop and Go, City, Backing, Squaring, Tight Maneuvering, Side Trailer, Reverse, and Parked. Some of these modes automatically activated in response to conditions, e.g., Reverse mode activated responsive to entering a reverse gear, while other modes required manual activation, such as Squaring mode for alignment guidance while backing a trailer, or Parked mode for activating a full perimeter of vehicle proximity sensors during unattended parking.

Some or all aspects of the aforementioned vehicle safety sensors and system would benefit from the incorporation of additional sensor and communication technologies, as would comparable driver information systems that increasingly integrate a range of vehicle monitoring and control functions. Additionally, new or expanded operating contexts (modes) would provide improved driver assistance and safety, and increase the convenience and control afforded to vehicle operators and owners.

### SUMMARY

In one or more embodiments, a vehicle safety system for use in a vehicle comprises a processing unit configured to detect vehicular events of interest, such as potentially hazardous vehicle operating conditions, based on processing vehicle sensor signals and, in response thereto, activate recording by one or more cameras mounted on the vehicle. In at least one such embodiment, a vehicle sensor interface included in or associated with the processing unit receives object detection signals from a number of object detection sensors, and a camera interface included in or associated with the processing unit provides recording activation control for the one or more cameras. In such embodiments, the processing unit processes object detection signals, which may be distance and/or proximity based, to detect vehicular events of interest and activates recording accordingly.

Capturing a visual record (still images and/or video) in response to detecting vehicular events of interest provides invaluable assistance in accident reconstruction and investigation, driver training, insurance payment and fraud investigation, etc. Storage elements, which may be digital or analog, or any combination thereof, are included in or associated with the processing unit, and provide a mechanism for retaining captured still images and video recorded by the cameras.

Complementing such retention, the processing unit includes or is associated with a communication interface, which may provide local direct connection and/or long or short-range wireless data transfer, and which allows extraction of the recorded camera data by an external system. In at least one embodiment, the communication interface comprises a satellite and/or cellular radio modem, enabling remote extraction of camera data and/or vehicle sensor data recorded by the processing unit during one or more events. Such data may be time/date stamped and recorded in an electronic log on a per-event basis, along with driver identification, vehicle identification, and location (GPS) information, for example.

Regardless of data logging details, the processing unit comprises hardware, software, or any combination thereof, and in at least one embodiment the processing unit is configured for installation in the vehicle. In another embodiment, the processing unit comprises all or part of a pre-existing vehicle information system, such as a driver information system including in-cab display, etc. For example, a pre-existing vehicle information system can be configured as the processing unit based on provisioning it with appropriate computer program instructions, firmware, programmed logic, or the like.

With all of the above in mind, in one or more embodiments a method of vehicular event recording comprises detecting a potentially hazardous operating condition of a vehicle having one or more cameras mounted thereon and in response thereto, activating recording by one or more of the cameras to capture images in a vicinity of the vehicle. In at least one such embodiment, detecting a potentially hazardous operating condition of the vehicle comprises processing one or more vehicle sensor signals at an on-board processing unit included in the vehicle to determine whether a potentially hazardous condition exists.

In at least one embodiment, a vehicle safety system includes the processing unit and includes or is associated with object detection sensors, which may comprise distance-type sensors, proximity-type sensors, or any combination thereof. Thus, processing one or more vehicle sensor signals at the processing unit to determine whether a potentially hazardous condition exists comprises evaluating object detection signals from the object detection sensors. Additionally or alternatively, processing one or more vehicle sensor signals at the processing unit to determine whether a potentially hazardous condition exists comprises processing at least one of an absolute or relative vehicle speed signal, a vehicle braking signal, a vehicle lateral acceleration signal, a vehicle lane departure signal, a vehicle turning indicator signal, and an object detection signal.

In the same or other embodiments, the method includes activating recording by one or more cameras responsive to manual input. For example, the processing unit is configured in one embodiment to activate recording by one or more cameras responsive to receiving user input, such as by button, switch, or touch-screen input directed to a user interface included in or associated with the processing unit. Additionally, one or more embodiments of the method comprise activating recording by one or more cameras responsive to determining that the vehicle is being placed in a parked, unattended condition. For example, the processing unit may selectively operate in a Parked mode, in which it activates camera recording responsive to detecting objects in the vicinity of the vehicle, particularly moving or approaching objects.

In another embodiment related to modal operation, a vehicle safety system configured for on-board use in a vehicle comprises a processing unit configured to receive sensor signals from one or more forward distance sensors associated with the vehicle, and to operate in first Front Detection mode in a first speed range and to operate in a second Front Detection mode in a second speed range below the first speed range. In the first and second Front Detection modes, the processing unit generates driver advisory signals as a function of detected distances between the vehicle forward object, and, wherein, as an additional feature of the second Front Detection mode, the processing unit selectively activates vehicle braking responsive to detecting immediately proximate forward objects. In at least one such embodiment, the processing unit activates recording of still images or video by a front-looking camera on the vehicle responsive to detecting objects within one or more defined distances in the first and second Front modes.

Additionally, or in another embodiment, a vehicle safety system configured for on-board use in a vehicle comprises a processing unit configured to receive sensor signals from one or more forward distance sensors associated with the vehicle, and to operate selectively in a Lane Change mode and in a Lane Departure mode. The processing unit functions in the Lane Change mode responsive to detecting vehicle turn indicator activation and, in Lane Change mode, generates driver advisory signals as a function of detecting the presence of objects on a turn-side of the vehicle. Further, the processing unit functions in the Lane Departure mode responsive to detecting lane departure by the vehicle in the absence of a corresponding vehicle turn indicator activation and, in Lane Departure mode, activates recording by one or more cameras mounted on the vehicle.

In another embodiment, a processing unit for a vehicle safety system is configured for driver point grading. For example, the processing unit records driver point information and or data related to vehicle operation, such as camera recordings and/or sensor readings, in response to detecting vehicular events of interest. In at least one such embodiment, the processing unit records driver point grading information in response to detecting a vehicular event of interest, such as a potentially hazardous operating condition, and records corresponding information in an electronic log. For example, such information includes or is associated with sensor information, such as triggering sensor or event information, and/or includes still images or video capture by activating camera recording. Event, grading, and other information can be retrieved via a communication interface included in or associated with the processing unit. In at least one embodiment, the communication interface comprises a wireless communication interface, e.g., satellite or cellular radio modem, and enables remote data extraction from the vehicle safety system.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a vehicle safety system (VSS).

FIG. 2 is a logic flow diagram of an embodiment of VSS processing.

FIG. 3 is a diagram of example vehicle sensor signal inputs for an embodiment of a VSS processing unit.

FIG. 4 is a diagram of an embodiment of vehicle sensor types and placements for use with a VSS.

FIG. 5 is a diagram of additional or alternative sensor types that may be present on the vehicle of FIG. 4 for use with a VSS.

FIG. 6 is a diagram of an embodiment of a VSS that includes a remote processing unit.

### DETAILED DESCRIPTION

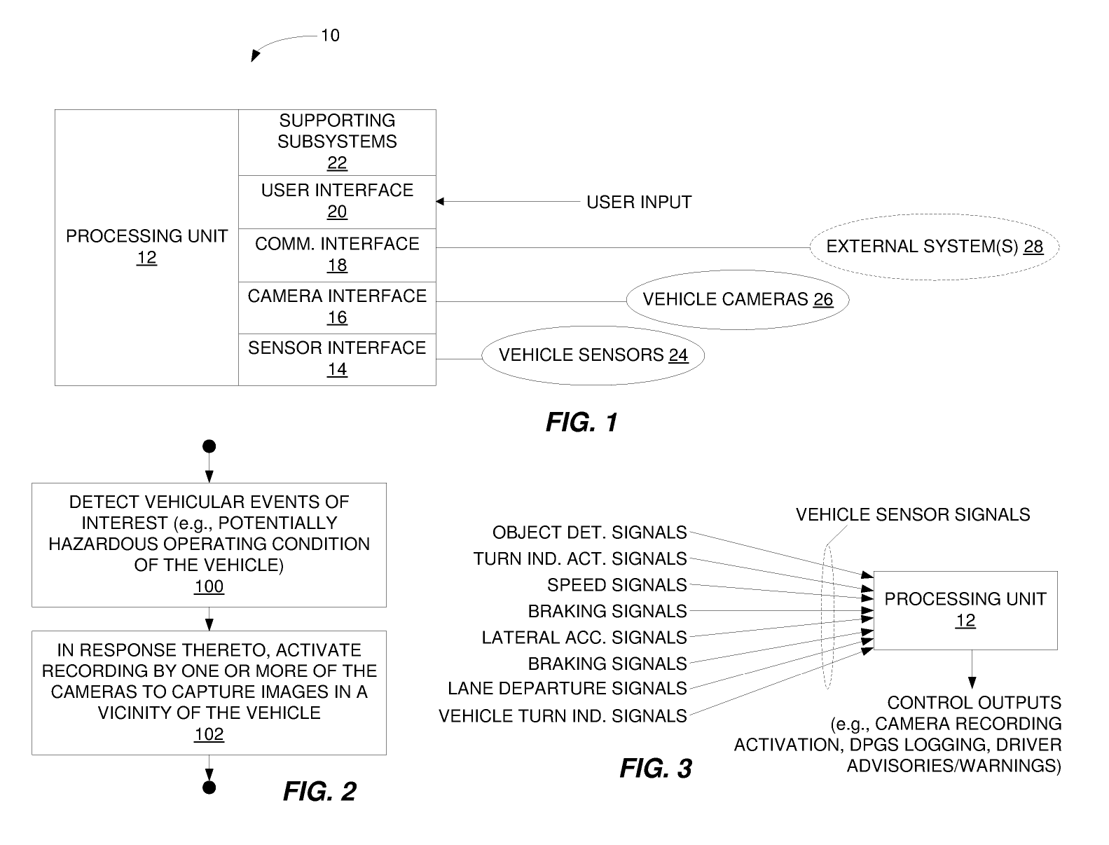

FIG. 1 illustrates a vehicle safety system (VSS) 10 comprising a processing unit 12, which includes or is associated with a sensor interface 14, a camera interface 16, a communication interface 18, a user interface 20, and one or more supporting circuits or subsystems 22. The sensor interface 14 communicatively couples the processing unit 12 directly or indirectly to one or more vehicle sensors 24, and the camera interface 16 likewise communicatively couples the processing unit 12 directly or indirectly to a number of cameras 26 mounted on the vehicle in which the VSS 10 is present. Further, the communication interface 18 communicatively couples the processing unit 12 directly or indirectly to one or more external systems 28, e.g., remote monitoring networks or systems, while the user interface 20 includes man-machine interface elements as needed or desired to allow interaction between the VSS 10 and an operator (e.g., the vehicle driver). Finally, the supporting circuits/subsystems 22 include, for example, GPS receivers, storage elements (non-volatile memory, hard disks, video recorders, etc.).

While offering tremendous configuration flexibility, in at least one embodiment the VSS 10 is configured to implement the processing logic illustrated in FIG. 2. According to the method embodiment of FIG. 2, the VSS 10 is installed or otherwise present in a vehicle, which by non-limiting example comprises a long-haul tractor-trailer or other road-going vehicle. In operation, the VSS 10 detects vehicular events of interest (Step 100), e.g., potentially hazardous operating conditions of the vehicle. In response thereto, VSS processing continues with the VSS 10 activating one or more of the cameras 26 mounted on the vehicle to capture images in a vicinity of the vehicle (Step 102). As such, the VSS 10 according to this method of operation captures and retains a potentially invaluable visual record of vehicular events, for use in accident investigation, insurance liability verification and fraud investigation, investigation of criminal activity involving or affecting the vehicle, etc.

As a more detailed introduction to event detection by the VSS 10, FIG. 3 illustrates an example set of vehicle sensor signals that the processing unit 12 receives, directly or indirectly. These signals originate from, or are associated with, a number of vehicle sensors, generically illustrated as “sensors 24” in FIG. 1. (Later herein, specifically identified sensors or sensor types are given different reference numbers, although it should be understood that later general references to vehicle sensors may still use the reference number 24.) Those skilled in the art will recognize that not all illustrated signals will be present (or used) in all configurations of the VSS 10; moreover, additional or alternate vehicle sensor signals may be present in some configurations of the VSS 10.

Additionally, in at least some embodiments of the VSS 10, the processing unit 12 operates in a number of modes, such as Front mode, Lane Change mode, Lane Departure mode, Backing/Reverse mode, Parked mode, and others. The particular mode may determine the priority of vehicle sensor signal processing by the processing unit 12, and may determine the particular ones of the vehicle sensor signals actively responded to by the processing unit 12. That is, the particular current operating mode(s) of the processing unit 12 may determine its response to individual vehicle sensor signals, or to combinations of those signals.

The VSS 10 may control camera activations as a function of its operating mode. For example, in at least one embodiment, the processing unit 12 is configured to operate selectively in a Stop and Go mode. Using rearward object detection, the processing unit 12 activates a rear-looking camera in response to detecting an object within a first defined distance (a warning zone). Camera activation in this sense does not necessarily entail the activation of recording, but preferably includes displaying the camera's data for the driver, e.g., on a display within the user interface 20, or on another display viewable by the driver. If the detected object moves closer, i.e., within a command or “red” zone, the processing unit 12 preferably begins video capture. Of course, the rearward vehicle example represents just one scenario. Similar camera activations and recordings may be triggered at low-speed modes in response to an object encroaching within predefined side/front/rear/top distances of the vehicle.

Broadly, one or more embodiments of the processing unit 12 are configured to activate cameras and corresponding driver displays in response to object detection within a first distance range, and to activate camera recording within a second, closer distance range. (Note, too, that at least one embodiment of the VSS 10 includes a processing unit 12 that is configured to allow manual camera activation and/or camera recording activation by the driver. Further, such manual activation may be implemented to complement modal operation of the processing unit 12. For example, object detection by particular sensors within a given mode causes the processing unit 12 to activate recording by particular ones of the cameras 26, but the processing unit 12 further allows the driver to manually activate camera recording for any ones of the cameras 26 not actively recording data.

As another example of modal operation, one embodiment of the VSS 10 comprises a processing unit 12 that is configured to receive sensor signals from one or more forward distance sensors associated with the vehicle, and to operate in first front detection mode in a first speed range and to operate in a second front detection mode in a second speed range below the first speed range. Vehicle speed may be sensed directly by interfacing the processing unit to one or more vehicle speed sensors via the sensor interface 14. However, in at least one embodiment, the sensor interface 14 includes or comprises a vehicle information bus interface (e.g., a “J-bus” interface), and the processing unit 12 receives vehicle speed signals as bus messages. In another embodiment, the vehicle speed signal is a derived signal obtained, for example, by processing GPS information.

Thus, it should be understood that for speed, as well as for other vehicle sensor signals, the signals may represent discrete digital or analog signals input to the sensor interface 14, may comprise electronic messages, and/or or may comprise derived signals. In that sense, it should be understood that the sensor interface 14 may comprise hardware, software, or any combination thereof, and may pass through signal information to the processing unit 12, may generate signal information for the processing unit 12, and/or may qualify or otherwise condition signal information for the processing unit 12. In this manner, the processing unit 12 can be configured to transition automatically between the first and second modes as a function of determining whether the vehicle is above or below a qualified speed threshold.

In any case, returning to the Front mode details, in the first and second front detection modes, the processing unit 12 generates driver advisory signals as a function of detected distances between the vehicle and a forward object. However, as an additional (distinguishing) feature of the second front detection mode, the processing unit 12 selectively activates vehicle braking responsive to detecting immediately proximate forward objects. Of course, the processing unit 12 also may be configured to initiate vehicle braking at low speeds responsive to detecting rearward or sideward proximate objects, as well as for forward objects.

The first and second speed ranges may be differentiated by a crossover value or speed threshold, e.g., 40 MPH. Of course, that may be an averaged or time-qualified speed value to prevent overly frequent transitioning by the processing unit between the first and second Front modes. Regardless, those skilled in the art will recognize that an added braking activation feature for second Front mode operation allows the VSS 10 to operate as a Collision Avoidance System (CAS) at lower speeds. Notably, the processing unit 12 may be configured to disable its activation of vehicle braking while operating in the second front detection mode in response to user mode control inputs and in response to driver activation of vehicle braking. That is, manual braking by the driver temporarily suspends braking initiation by the VSS 10, to prevent interfering with the driver's use of the vehicle brakes.

As more second Front mode operational details, the processing unit 12 is, in one or more embodiments of the second Front mode, configured to generate driver advisory signals as a function of detected distances between the vehicle and a forward object. In at least one such embodiment, the processing unit 12 detects a forward object falling within a first defined distance, and provides proximity advisory signals, including at least one of an audible advisory signal, a visible advisory signal, and a tactile advisory signal. Further, for a detected forward object falling within a second defined distance, providing a stop advisory signal, e.g., a “STOP” voice command or emphasized visual alert (red light or icon), and for a detected forward object detected as being immediately proximate in the forward direction, selectively activating vehicle braking. In this sense, “selectively” activating vehicle braking denotes that the processing unit 12 would forego or suspend its braking activation if it senses braking activation by the driver, and/or if that feature has been disabled, braking activation conflicts with a higher-priority operating mode active within the processing unit 12.

Further, regarding selective vehicle braking activation, the processing unit 12 may be configured for CAS operation in other modes, such as those involving reverse or other low-speed maneuvering, wherein it selectively activates vehicle braking responsive to object detection. However, as a general configuration feature, activation of vehicle braking by the VSS 10 is limited to lower speeds, i.e., speeds at or below a defined speed threshold. In this manner, the VSS 10 foregoes activation of vehicle braking at or above the defined (low) speed threshold.

Turning to first Front mode operational details, the higher-speed, first Front mode of operation effectively configures the VSS 10 as a Collision Warning System (CWS), wherein the processing unit 12 issues driver advisories/warnings but the processing unit 12 does not initiate vehicle braking, given the higher vehicle speeds involved. However, in this mode, the processing unit 12 is configured to generate driver advisory signals as a function of detected distances between the vehicle and a forward object based on, for a detected forward object falling within a first forward distance range, providing following-too-close advisory signals, including at least one of an audible advisory signal, a visible advisory signal, and a tactile advisory signal. Additionally, the processing unit 12 starts a grace period timer, which may be a software or hardware timer maintained within the processing unit 12.

Upon expiration of the grace period time and if the detected forward object is still too close as determined relative to the first forward distance range, the processing unit 12 provides one or more supplemental following-too-close advisory signals, and assesses driver grading points in a Driver Point Grading System function of the processing unit 12. The processing unit 12 also may be configured to compute the speed of the vehicle relative to the leading vehicle, and calculate the speed necessary to maintain an acceptable following distance. That speed may be displayed and/or announced by the user interface 20.

Further, in at least one embodiment of first and second Front modes of operation, the processing unit 12 activates recording of still images or video by a front-looking camera 26 on the vehicle responsive to detecting objects within one or more defined distances in the first and second Front modes. In this manner, the processing unit 12 captures still images and/or video from at least front-looking cameras in response to detecting objects within one or more defined distance ranges, and in that way provides potentially invaluable data for accident investigation, etc.

Additionally, in at least one embodiment of Front mode operation, if the driver fails to heed the advisory within the grace period, the VSS 10 transmits a signal to a remote system, such as a monitoring center. That signal may include the vehicle's current speed, the detected distance to the object, e.g., the following distance, and the remote system may command the vehicle to slow down. That command may be received and processed by the VSS 10, may be passed though the VSS 10 to other onboard processing systems within the vehicle for action, or may be communicated separately to another processing system in the vehicle, such as through a satellite or cellular link. The remote system further may send calculated speed information related to maintaining the desired following distance.

In another example of mode-based operation, in one or more embodiments of the VSS 10, the processing unit 12 is configured to receive sensor signals from one or more forward distance sensors associated with the vehicle, and to operate selectively in a Lane Change mode and in a Lane Departure mode. The processing unit 12 functions in the Lane Change mode responsive to detecting vehicle turn indicator activation. In Lane Change mode, the processing unit 12 generates driver advisory signals as a function of detecting the presence of objects on a turn-side of the vehicle. Note, too, that in one or more embodiments of Lane Change mode, the processing unit 12 activates recording by rear-looking and/or side-looking cameras in response to detecting an indicated lane change or turn.

More particularly, in one embodiment of Lane Change mode, the processing unit 12 detects whether any turn-side objects are proximate to the vehicle in response to detecting vehicle turn indicator activation. If so, the processing unit 12 generates a corresponding driver advisory, such as a blinking red arrow. As a further feature, the processing unit 12 may activate recording by one or more cameras 26. For example, the processing unit may activate recording by any one or more of rear-looking, side-looking, and front-looking cameras in response to detecting objects during signaled lane changes.

If no turn-side proximate object is detected, the processing unit 12 generates a corresponding driver advisory, such as a green blinking arrow, to confirm that it is clear to execute the indicated turning maneuver. However, as noted, the processing unit 12 also may detect whether there are any proximate objects on the opposite side of the vehicle, or to the rear of the vehicle, and, if so, activate camera recording for those vicinities of the vehicle. Doing so allows the processing unit 12 to capture still images or video of adjacent vehicles, pedestrians, etc., that may move unexpectedly while the vehicle executes the indicated maneuver.

Whereas activation of the vehicle's turn indicators signifies a purposeful course deviation, e.g., lane change, the processing unit 12 functions in the Lane Departure mode responsive to detecting lane departure by the vehicle in the absence of a corresponding vehicle turn indicator activation. For example, in one embodiment of Lane Departure mode, the processing unit 12 detects that the vehicle is deviating from its lane absent any turn signal activation and in response checks for object detections from one or more object detection sensors. If objects, such as a nearby turn-side object, are detected, the processing unit 12 outputs appropriate driver advisories, such as by flashing a red display light or other warning indicator, voice prompting, etc., and activates recording by one or more of the cameras 26. For example, it may activate recording by front, rear, and side-looking cameras, or one or more of such cameras.

In other words, one or more of the vehicle sensors 24 provide the processing unit 12 with an indication of the vehicle's departure from its current lane of travel and, if that departure does not correspond to a signaled change, the processing unit 12 transitions to Lane Departure mode. In Lane Departure mode, the processing unit 12 activates recording by one or more cameras mounted on the vehicle, either triggered by detection of the departure event, or by detection of the departure event in combination with object detection.

At least one embodiment of the VSS 10 integrates Lane Detection, GPS navigation, infrared camera technology, and collision/event camera capture. Basic Lane Changing Mode activates turn-side object detection sensors upon activation of a vehicle turn indicator, and gives corresponding alarms/warnings responsive to detection of proximate objects on the turn-side of the vehicle. Lane Changing Mode operational features include the activation of opposite side sensors not for alarming but rather for data recording, i.e., to record what was around the vehicle when the lane change or turn began.

Of course, the VSS 10 may be configured to record additional parameters associated with the lane change event, such as lane departure rate/time, lane-to-lane transition time, etc. Further, Lane Changing Mode may also include the activation of side-looking and rear-looking ones of the cameras 26 to record a visual record of the lane change event. All such data can be extracted from the VSS 10 via the communication interface 18, which may be wireless (satellite, cellular, Bluetooth, WiFi, WiMax, infrared, near-field electromagnetic, etc.).

In addition, accurate lane marker recognition, such as machine-vision based highway marker recognition and tracking, allows the VSS 10 to accurately and quickly transition into Lane Departure mode, wherein the processing unit 12 gives driver warnings (sound, vibration, etc.) responsive to detecting out-of-lane deviations. In at least one embodiment, the processing unit 12 is configured to provide both driver warnings and exterior warnings (i.e., warnings to drivers of proximate vehicles). For example, one embodiment of the processing unit 12 is configured to activate the vehicle's “city horn” in response to detecting lane departure within a certain speed range, e.g., between 35 mph and 55 mph, and to activate the vehicle's air horn in response to detecting lane departure at speeds above 55 mph. Horn activation in this manner advantageously warns the vehicle's driver of a lane deviation, while also warning drivers of nearby vehicles.

The VSS 10 records lane deviation parameters for later reporting and can notify owners/authorities if an excessive lane deviation occurs, or if an excessive frequency of lane deviations occurs.

Of course, there may be some instances where lane deviation occurs, or apparently occurs, in which it may be inappropriate unfairly penalize the driver via point grading, where it may be inappropriate to give warnings. For example, the transition from marked to unmarked pavement may appear as a lane deviation to the lane detection sensor(s) 44. As another example, the driver may be required to execute a controlled detour around a highway obstacle, or transition into a detour or temporary highway construction lane. As such, in at least one embodiment, the processing unit 12 is configured to disable it Lane Departure actions in response to sensing activation of the vehicle's flashers (hazard lights). Additionally, or alternatively, the Lane Departure mode may be temporarily disabled by the driver or by a remote system in communication with the VSS 10. In general, the processing unit 12 is configured to re-enable the Lane Departure mode after a defined period elapses.

Lane deviations also may trigger camera activation for event recording. In at least one embodiment, all such events and warnings are recorded, including camera and sensor data, and driver warnings may intensify with increasing time-in-deviation. In addition, all such events relate to the processing unit's optional Driver Point Grading System (PGS) function, which maintains a driver grading point system as a historical record based on detected vehicular events and the driver's response thereto.

Additionally, the processing unit 12 may detect seatbelt on/off conditions for driver point grading purposes. Further, whether driver point grading functions are present or active, the processing unit 12 may record seatbelt status in its electronic log(s) for later review and/or may actively transmit a signal to a remote system in response to detecting a driver's failure to buckle up. (Such reporting may be time-qualified, i.e., the driver must be unbelted for a period of time before the VSS 10 transmits an outgoing alert or logs the incident.)

In a more general implementation of the driver point grading system function, the processing unit 12 is configured to driver point grading information based on detecting vehicular events, such as any one or more of speeding, following-too-closely, abrupt maneuvering, un-signaled lane deviations (departures), signaled turn events with turn-side proximate objects detected, braking emergency events (detected as wheel lock or excessive braking pressure), and so on. Notably, in any or all such events, the VSS 10 can activate one or more of the cameras 26, to capture still images or video for relevant vicinities surrounding the vehicle, and such camera data can be date/time stamped, event-stamped, or otherwise logically associated with the logged event record.

Driver point grading information and, in general, event information, can be stored securely so that it is not modifiable or erasable by drivers or other personnel not authorized to view, retrieve, extract, or otherwise work with the stored electronic event logs and driver point grading information. Moreover, such information can be retrieved locally or remotely at the end of a trip, or in real-time or near real-time. For example, in embodiments of the VSS 10 that include a wireless communication interface 18, vehicle owners, fleet managers, civil authorities, or other parties as authorized can extract event logs, driver point grading information, and essentially any other information stored by the VSS 10 at any time.

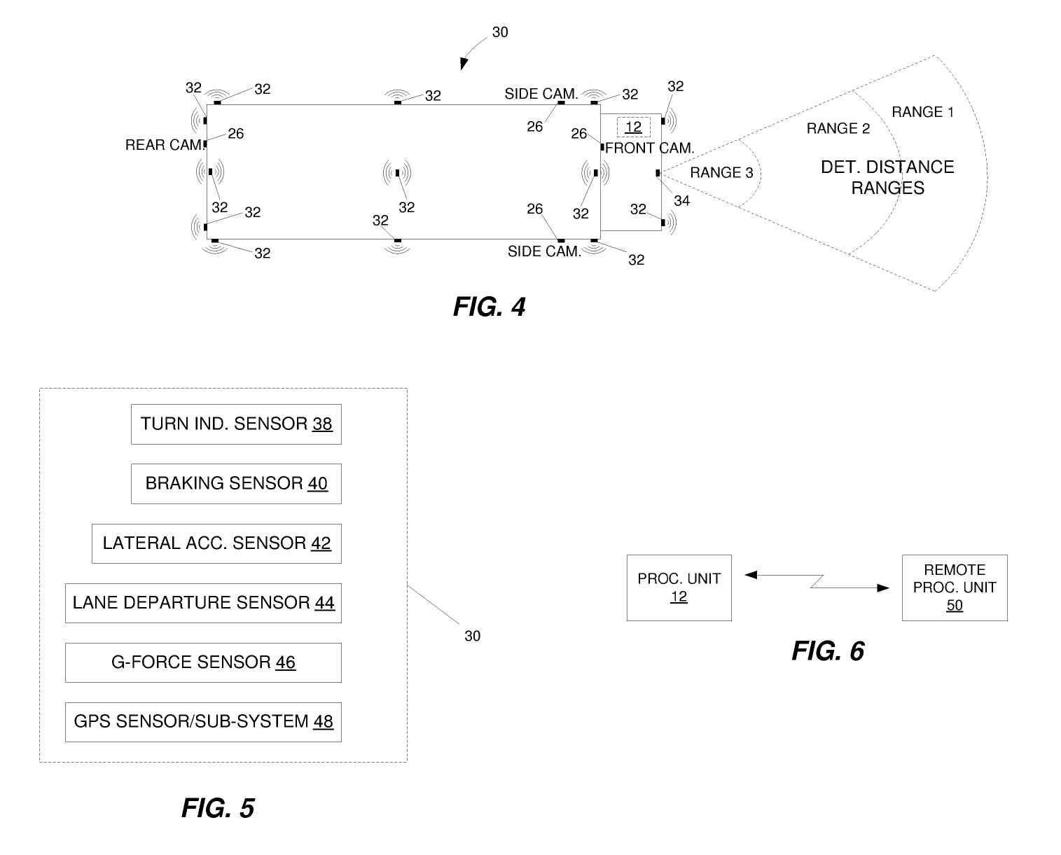

Of course, whether driver point grading is implemented or not, event recording provides valuable information in the form of electronic logs or other archival data, related to the operation of the vehicle. To better appreciate these and other capabilities of the VSS 10, FIG. 4 illustrates a vehicle 30 having a plurality of detection sensors 32 distributed around its exterior (sides, rear, front, top), and at least one object detection sensor 34 for forward distance detection.

By way of non-limiting example, the object detection sensors 32 comprise capacitive, inductive, infrared, ultrasonic, or other type of proximity-type object detection sensors. Thus, in one or more embodiments, the object detection sensors 32 trigger (assert) output signals responsive to objects coming within their detection ranges. In other embodiments, one or more of the object detection sensors 32 provide true distance sensing, and thus can report distances, or can qualify their output signal assertion based on one or more defined distance ranges. In at least one such embodiment, the processing unit 12 is configured to present the driver or VSS operator with a distance programming function that allows programming of the detection distances, e.g., an advisory distance range and a closer, warning distance range.

As a further example, the object detection sensor 34 comprises a distance-type object detection sensor using light-based distance measurement, such as a laser scanner that determines distances based on laser pulse flight time or laser signal frequency shift. Of course, other technologies, such as ultrasonic, radar, etc. may be used, and distance detection sensors may be used on the rear and sides of the vehicle 30, as well. Still further, one or more of the object detection sensors 32 and 34 may comprise “hybrid” sensors providing proximity detection and distance measurement, and may blend two or more detection technologies.

In any case, the processing unit 12 is present within the vehicle 30, such as mounted or otherwise integrated within the cab of the vehicle 30, and interfaces directly or indirectly to the object detection sensors 32 and 34 via wired or wireless links. Thus, the processing unit 12 in at least one embodiment detects vehicular events based on processing object detection signals from the object detection sensors 32 and 34, and correspondingly activates recording by one or more of the cameras 26, which are mounted on the vehicle 30. By way of non-limiting example, FIG. 4 illustrates side-looking, rear/top-looking, and front/top-looking cameras. In this manner, the processing unit 12 can capture still images or video from any vicinity around or above the vehicle 30 in response to object detection. Of course, determining whether to activate recording by which cameras may be a function of the particular vehicular event detected, and/or the current operating mode of the processing unit 12. (Note that activating recording by one or more of the cameras 26 also may include actuating tilt/zoom/pan controls in embodiments where one or more of the cameras offer such features.)

More broadly, the object detection signals from the object detection sensors 32 and 34 are considered one type of vehicle sensor signal. FIG. 5 illustrates additional or alternate types of vehicle sensor signals that may be received and processed by the processing unit 12 as a basis for its vehicular event detection. In more detail, FIG. 5 illustrates a turn indicator sensor 38, a braking sensor 40, a lateral acceleration sensor 42, a lane departure sensor 44, a g-force (bump/impact) sensor 46, and a GPS sensor/subsystem 48, which may be included in the supporting subsystems 22 shown in FIG. 1, or may be a separate system available within the vehicle 30.

In looking at these “sensors” in more detail, those skilled in the art should appreciate that the processing unit 12 may interface directly to a discrete sensor, or may receive sensor signals as vehicle information bus messages via the vehicle information bus interface included in the sensor interface 14 shown in FIG. 1. Moreover, rather than getting an immediately usable sensor signal, the processing unit 12 and/or the sensor interface 14 which may be included within it, may perform signal conditioning or other processing to generate a usable sensor signal. For example, a braking emergency signal may be provided to the sensor interface 14 by a vehicle information bus or via discrete signaling, or the signal may be derived by monitoring a braking pressure indicator, a wheel lock/ABS activity indicator, etc. Likewise, vehicle turn indicator signals may be provided via discrete signaling driven by activation of the vehicle's turn signals, or may be obtained via intelligent information bus signaling.

With FIGS. 4 and 5 in mind, one appreciates that one or more embodiments of the VSS 10 broadly function as a vehicle safety system for vehicular event recording. In such embodiments, the processing unit 12 is configured to detect a potentially hazardous operating condition of the vehicle 30. In response thereto, the processing unit 12 activates recording by one or more of the cameras 26 to capture images (still and/or video) in a vicinity of the vehicle 30. Further, as illustrated, the processing unit 12 comprises a computer system installed within the vehicle 30 and communicatively coupled to one or more vehicle sensors (e.g., 32, 34, 38, and so on). The processing unit 12 thus comprises software, firmware, or program logic configured to detect potentially hazardous operating conditions of the vehicle based on processing input signals associated with the vehicle sensors. That is, the processing unit 12 detects a potentially hazardous operating condition of the vehicle 30 by processing one or more vehicle sensor signals to determine whether a potentially hazardous condition exists.

As one example, the processing unit 12 evaluates object detection signals from the object detection sensors 32 and/or 34 to determine whether a potentially hazardous operating condition exits, such as by detecting the activation of distance-triggered signals from one or more object detection sensors. As previously noted, the processing unit 12 may be configured to receive user input defining one or more programmed distance ranges and provide corresponding distance range information to one or more of the object detection sensors 32 and/or 34 to set one or more triggering distances.

Further, and with particular reference to FIG. 5, the processing unit 12 may additionally or alternatively process other types of vehicle sensor signals to detect hazardous operating conditions. For example, it may process at least one of an absolute or relative vehicle speed signal, a vehicle braking signal, a vehicle lateral acceleration signal, a vehicle lane departure signal, a vehicle turn signal, and an object detection signal. Notably, the processing unit 12 can use closing distance determinations, such as the distance-closing rate between the vehicle 30 and a leading vehicle as detected via object detection sensor 34, to determine the speed of the vehicle 30 relative to other vehicles.

In these or other embodiments, the processing unit 12 detects vehicle turn signal activation as a potentially hazardous operating condition of the vehicle 30, and may activate one or more cameras 26 to capture surrounding vicinity images to capture any incident that might arise as the vehicle 30 executes the indicated maneuver. In at least one embodiment, the processing unit 12 detects vehicle turn signal activation in conjunction with detecting object proximity in a lateral vicinity of the vehicle as a potentially hazardous operating condition of the vehicle 32. In other embodiments, the processing unit 12 detects lane changes by the vehicle 30 in the absence of turn indicator activation as a potentially hazardous condition, and initiates camera recording in response thereto.

More broadly, the processing unit 12 detects lane departures as a potentially hazardous operating condition. The lane departure sensor(s) 44 may comprise machine vision sensors having their own camera subsystems, or using one or more of the cameras 26 mounted on the vehicle 30, for visualizing painted highway and road markings, including lane lines. As a non-limiting example, MOBILEYE INC. provides powerful image processing systems and modules, e.g., the EYEQ system-on-a-chip, which can be readily configured for lane departure detection. MOBILEYE INC. maintains a U.S. office at 2000 Town Center, Suite 1900, Southfield, Mich. 48075.

In any case, once it detects a potentially hazardous operating condition of the vehicle 30, at least one embodiment of the processing unit 12 activates still image capture and/or video capture by one or more of the cameras 26. In more detail, at least one embodiment of the processing unit 12 activates recording by all cameras 26 responsive to detecting a vehicular event, such as a potentially hazardous operating conditions. In one or more other embodiments, the processing unit 12 activates particular ones of the one or more cameras 26 as a function of the particular vehicle event detected, e.g., the particular potentially hazardous condition detected.

For example, the processing unit 12 activates at least a rear-looking camera 26 responsive to detecting an emergency braking condition. In another example, the processing unit 12 activates at least a front-looking camera 26 responsive to detecting at least one of a following-too-close condition of the vehicle 30 relative to another vehicle and an excessive closing speed condition of the vehicle 30 relative to another vehicle. In yet another example, the processing unit 12 activates at least one side-looking camera 26 responsive to detecting a lane departure by the vehicle 30 and/or a vehicle turn signal activation. Additionally, or alternatively, the processing unit 12 may activate front-camera and/or rear camera recording during signaled lane changes or un-signaled lane departures.

As another example of the processing unit 12 activating recording by one or more of the cameras 26, the processing unit 12 may be configured to operate selectively in a Parked mode. For example, the vehicle driver may provide input to the processing unit 12 via the user interface 20, indicating that the vehicle is being left in an unattended parked condition. In response thereto, the processing unit 12 may activate recording by one or more of the cameras 26 to capture images in a vicinity of the vehicle 30. More particularly, the processing unit 12 may monitor object detection signals for any changes (movement, approach, etc.) and activate one or more of the cameras 26 as a function of the object detection event. Additionally, the processing unit 12 may be configured to activate recording by one or more of the cameras 26 to capture images in a vicinity of the vehicle, in response to a manual activation signal. Again, the VSS operator may be presented with various controls via the user interface 20 to provide such input.

In another aspect of the VSS 10 related to the Parking mode, at least one embodiment of the VSS 10 comprises a handheld version of the processing unit 12, which offers some or all of the features of the processing unit 12. Indeed, in some embodiments, the processing unit 12 is implemented as a portable device that interfaces with vehicle sensors via a wiring harness, wireless connection etc. In any case, FIG. 6 illustrates an embodiment of the VSS 10 wherein a remote processing unit 50 provides wireless communication with the in-vehicle processing unit 12 of the VSS 10.

Notably, the remote processing unit 50 may comprise a dedicated computer-based handheld device having, for example, a user interface that wholly or partially mimics the user interface 20 of the processing unit 12. In other embodiments, the processing unit 50 comprises a general-purpose computing device, such as a laptop computer or PDA, executing computer program instructions embodying the desired remote monitoring and control functionality.

Regardless of its particular implementation, as just one example of its functionality, the operator of the vehicle 30 places the processing unit 12 in the Parked mode, such that it activates monitoring of vehicle sensors and subsequently sends corresponding signaling to the remote processing unit 50. In this manner, for example, the remote processing unit 50 receives object detection event messages or alarms, other advisories and warnings, etc.

Further, with even low bandwidth wireless links, one or more embodiments of the processing unit 12 can be configured to send still image and/or audio data from vehicle cameras 26 to the remote processing unit 50. With higher bandwidth connections, the processing unit 12 can be configured to send real-time or recorded video and audio to the remote processing unit 50. Additionally, one or more embodiments of the remote processing unit 50 are configured to relay sensor data and/or other information from the vehicle 30 to authorities or other authorized remote monitors. In one particular embodiment, the remote processing unit 50 selectively sends video or still images received from the processing unit 12 (as captured by one or more of the cameras 26) to a remote system, i.e., the remote processing unit 50 relays stored, real-time, or near real-time camera data from the vehicle 30 to a remote party.

As another aspect of remote monitoring, and one which may be implemented with or without use of the remote processing unit 50, sensors 24 and cameras 26 located on the trailer portion of a tractor-trailer vehicle may include their own power sources, or may otherwise be supplied with a source of power available on the trailer. As such, the driver may disconnect the tractor from the trailer without deactivating the sensing functions of the sensors 24 on the trailer, and without losing the ability to activate cameras 26 mounted on the trailer. With wireless signaling between the processing unit 12 (or the processing unit 50) and the trailer-mounted sensors 24 and cameras 26, the processing unit 12 (or 50) can continue monitoring sensors signals, and activating camera recording as needed. As one example, the sensors 24 include one or more object detection sensors and/or door tamper/intrusion sensors, and camera recording is activated in response to the approach of an object (person, etc.) or in response to detecting opening of the trailer.

In yet another aspect of VSS operation in at least one embodiment, the processing unit 12 is configured to operate selectively in a Message Alert mode, which may be combined with other operating modes. In Message Alert mode, the processing unit 12 provides incoming information, e.g., incoming satellite and/or cellular-received data, to the driver, such as by displaying it and/or providing voice output. Incoming data includes, for example, emails, route updates, weather information, Amber Alerts, Homeland Security Alerts, etc. Advantageously, the communications interface 18 and/or the user interface 20 included in or associated with the processing unit 12 includes a Bluetooth or other local wireless communication interface. As such, voice and other audio information may be sent to the driver by the processing unit 12, and received from the driver, in a hands-free context.

In a still further aspect of VSS operation, and with particular reference back to FIG. 4, at least one embodiment of the VSS 10 includes a processing unit 12 that is configured to activate one or more external indicators (not explicitly shown) on the vehicle 30. For example, a trailer portion of vehicle may include supplemental exterior lights on its sides and its rear, which can be activated by the processing unit 12. As one example, these lights may be used to alert vehicles when they are in a blind spot of the vehicle 30, or beside the vehicle 30 at the beginning of a signaled lane change or turn. More generally, the processing unit 12 may be configured to control one or more exterior warning indicators as a function of its vehicle sensor signal processing and modal operation, as a mechanism for providing surrounding vehicles, pedestrians, and others, with warning information.

With the above embodiments and details in mind, those skilled in the art will appreciate that one or more embodiments of the VSS 10 incorporate features and technologies to provide robust and powerful operational monitoring and accident reconstruction for road-going vehicles. By providing operating modes, and complementary combinations of modes and/or automatic transitioning between modes as a function of conditions or context, the VSS 10 uses its associated sensors to prove distance, speed, and timing detections. In turn, based on processing/evaluating those detections, the VSS 10 provides corresponding advisories, warnings, and commands, and can tailor those outputs as a function of condition urgency, e.g., object proximity, closing speeds, etc.

Further, as a function of its sensor detections, the VSS 10 triggers or otherwise activates data recording, including camera recording and various sensor data. Such data provides an invaluable record for accident investigation, and may be held in one or more electronic logs retained in memory or storage elements accessible to the VSS 10, such as memory (e.g., FLASH cards) or disk drives included in the supporting subsystems 22 of FIG. 1. (Note, too, that various ones of the sensors 24 and/or cameras 26 may have or can be associated with memory.) Thus, data may be stored centrally or in a distributed fashion for accident investigations, round-the-clock driver point grading functions, etc.

Stored data may be extracted via the communication interface 18 of the processing unit 12, which, as noted, may provide wireless communication capabilities. Indeed, in embodiments of the VSS 10 that include satellite or cellular radio modems (or that make use of the vehicle's wireless communication systems), camera, sensor, driver point grading, and other data may be extracted in real-time or near real-time from the VSS 10.

Additionally, the VSS 10 can be configured such that the processing unit 12 transmits, directly or by using an in-vehicle transmitter, status information to a remote party, such as a monitoring station, legal authorities, etc. For example, the processing unit 12 may be configured to transmit status information automatically in response to detecting impacts, detecting the driver's failure to honor grace period timings related to speeding, following-too-close, etc., or detecting overly frequent or numerous vehicle events of one or more given types, such as excessive lane deviations.

Still further, wireless communication with the VSS 10 enables a number of valuable features. For example, in one embodiment, the VSS 10 is configured for remote feature disabling, wherein the vehicle owner, fleet management center, or VSS subscription services management center, remotely configures which features or modes within the VSS 10 will be active. Of course, at least one embodiment of the VSS 10 also supports local feature disabling, whether by a laptop connection or directly through its user interface 20. In all cases, however, feature enabling/disabling functions may be protected via password authorization or other authentication features provided by the VSS 10.

By enabling remote feature enabling/disabling, the same type of VSS 10 can be installed in different vehicles but offer different capabilities and functions in each vehicle, depending on the particular features enabled or disabled for that vehicle. Among other things, this capability allows vehicle operators/owners, fleet managers, or subscription service managers, to tailor VSS operation for individual vehicles and/or for groups of vehicles. In turn, that ability enables a business model wherein the purchase price of a given VSS 10 and/or the monthly subscription fee due on it can be varied as a function of which features are enabled or disabled. Further, for additional cost, new features could be remotely downloaded or pre-existing features can be remotely enabled. Thus, at least one embodiment of the VSS 10 supports remote upgrading and/or subscription-based services, wherein features are enabled or disabled (or added or deleted) as a function of ongoing service subscription payments.

As such, the present invention is not limited by the foregoing description and accompanying drawings. Instead, the present invention is limited only by the following claims and their legal equivalents.

What is claimed is:

1. A method of vehicular event recording comprising:
detecting a potentially hazardous operating condition of a vehicle having one or more cameras mounted thereon; and
in response thereto, activating recording by one or more of the cameras to capture images in a vicinity of the vehicle.

2. The method of claim 1, wherein detecting a potentially hazardous operating condition of a vehicle having one or more cameras mounted thereon comprises processing one or more vehicle sensor signals at an on-board processing unit included in the vehicle to determine whether a potentially hazardous condition exists.

3. The method of claim 2, wherein one or more object detection sensors are mounted on the vehicle and operatively associated with the on-board processing unit, and wherein processing one or more vehicle sensor signals at an on-board processing unit included in the vehicle to determine whether a potentially hazardous condition exists comprises evaluating object detection signals from the object detection sensors.

4. The method of claim 3, wherein evaluating object detection signals from the object detection sensors comprises detecting the activation of distance-triggered signals from one or more object detection sensors.

5. The method of claim 4, further comprising receiving user input defining one or more programmed distance ranges and providing corresponding distance range information to one or more of the object detection sensors to set one or more triggering distances.

6. The method of claim 2, wherein processing one or more vehicle sensor signals at an on-board processing unit included in the vehicle to determine whether a potentially hazardous condition exists comprises processing at least one of an absolute or relative vehicle speed signal, a vehicle braking signal, a vehicle lateral acceleration signal, a vehicle lane departure signal, a vehicle turn signal, and an object detection signal.

7. The method of claim 1, wherein detecting a potentially hazardous operating condition of a vehicle having one or more cameras mounted thereon comprises detecting vehicle turn signal activation.

8. The method of claim 7, wherein detecting a potentially hazardous operating condition of a vehicle having one or more cameras mounted thereon further comprises detecting vehicle turn signal activation in conjunction with detecting the presence of a proximate object in a lateral vicinity of the vehicle.

9. The method of claim 1, wherein detecting a potentially hazardous operating condition of a vehicle having one or more cameras mounted thereon comprises detecting a lane departure by the vehicle.

10. The method of claim 1, further comprising activating recording by one or more of the cameras to capture images in a vicinity of the vehicle responsive to a manual activation signal.

11. The method of claim 1, further comprising activating recording by one or more of the cameras to capture images in a vicinity of the vehicle in response to detecting activation of an object detection sensor signal subsequent to receiving an input signal indicating that the vehicle is being placed in an unattended parked condition.

12. The method of claim 1, wherein activating recording by one or more of the cameras to capture images in a vicinity of the vehicle comprises activating at least one of still image capture and video capture by one or more of the cameras.

13. The method of claim 1, wherein activating recording by one or more of the cameras to capture images in a vicinity of the vehicle comprises activating particular ones of the one or more cameras as a function of the particular potentially hazardous condition detected.

14. The method of claim 13, wherein activating particular ones of the one or more cameras as a function of the particular potentially hazardous condition detected comprises activating at least a rear-looking camera responsive to detecting an emergency braking condition.

15. The method of claim 13, wherein activating particular ones of the one or more cameras as a function of the particular potentially hazardous condition detected comprises activating at least a front-looking camera responsive to detecting at least one of a following-too-close condition of the vehicle relative to another vehicle and a excessive closing speed condition of the vehicle relative to another vehicle.

16. The method of claim 13, wherein activating particular ones of the one or more cameras as a function of the particular potentially hazardous condition detected comprises activating at least one side-looking camera responsive to detecting at least one of a lane departure by the vehicle and a vehicle turn signal activation.

17. The method of claim 1, further comprising, in response to detecting a potentially hazardous operating condition of the vehicle, recording driver point grading system information in logical association with still images or video recorded by the one or more cameras.

18. A vehicle safety system for vehicular event recording, said vehicle safety system comprising a processing unit configured to:
detect a potentially hazardous operating condition of a vehicle having one or more cameras mounted thereon and having the vehicle safety system present therein; and
in response thereto, activate recording by one or more of the cameras to capture images in a vicinity of the vehicle.

19. The vehicle safety system of claim 18, wherein the processing unit comprises a computer system installed within the vehicle and communicatively coupled to one or more vehicle sensors, said computer system including software, firmware, or program logic configured to detect potentially hazardous operating conditions of the vehicle based on processing input signals associated with the vehicle sensors.

20. The vehicle safety system of claim 18, wherein the processing unit detects a potentially hazardous operating condition of the vehicle by processing one or more vehicle sensor signals to determine whether a potentially hazardous condition exists.

21. The vehicle safety system of claim 20, wherein one or more object detection sensors are mounted on the vehicle and operatively associated with the processing unit, and wherein the processing unit processes one or more vehicle sensor signals to determine whether a potentially hazardous condition exists based on evaluating object detection signals from the object detection sensors.

22. The vehicle safety system of claim 21, wherein the processing unit evaluates object detection signals from the object detection sensors by detecting the activation of distance-triggered signals from one or more object detection sensors.

23. The vehicle safety system of claim 22, wherein the processing unit receives user input defining one or more programmed distance ranges and provides corresponding distance range information to one or more of the object detection sensors to set one or more triggering distances.

24. The vehicle safety system of claim 20, wherein the processing unit processes one or more vehicle sensor signals to determine whether a potentially hazardous condition exists by processing at least one of an absolute or relative vehicle speed signal, a vehicle braking signal, a vehicle lateral acceleration signal, a vehicle lane departure signal, a vehicle turn signal, and an object detection signal.

25. The vehicle safety system of claim 18, wherein the processing unit detects vehicle turn signal activation as a potentially hazardous operating condition of the vehicle.

26. The vehicle safety system of claim 18, wherein the processing unit detects vehicle turn signal activation in conjunction with detecting object proximity in a lateral vicinity of the vehicle as a potentially hazardous operating condition of the vehicle.

27. The vehicle safety system of claim 18, wherein the processing unit detects lane departure as a potentially hazardous operating condition of the vehicle.

28. The vehicle safety system of claim 18, wherein the processing unit activates recording by one or more of the cameras to capture images in a vicinity of the vehicle responsive to a manual activation signal.

29. The vehicle safety system of claim 18, wherein the processing unit activates recording by one or more of the cameras to capture images in a vicinity of the vehicle in response to detecting activation of an object detection sensor signal subsequent to receiving an input signal indicating that the vehicle is being placed in an unattended parked condition.

30. The vehicle safety system of claim 18, wherein the processing unit activates recording by one or more of the cameras to capture images in a vicinity of the vehicle by activating at least one of still image capture and video capture by one or more of the cameras.

31. The vehicle safety system of claim 18, wherein the processing unit activates particular ones of the one or more cameras as a function of the particular potentially hazardous condition detected.

32. The vehicle safety system of claim 31, wherein the processing unit activates particular ones of the one or more cameras as a function of the particular potentially hazardous condition detected by activating at least a rear-looking camera responsive to detecting an emergency braking condition.

33. The vehicle safety system of claim 32, wherein the processing unit activates particular ones of the one or more cameras as a function of the particular potentially hazardous condition detected by activating at least a front-looking camera responsive to detecting at least one of a following-too-close condition of the vehicle relative to another vehicle and a excessive closing speed condition of the vehicle relative to another vehicle.

34. The vehicle safety system of claim 32, wherein the processing unit activates particular ones of the one or more cameras as a function of the particular potentially hazardous condition detected by activating at least one side-looking camera responsive to detecting at least one of a lane departure by the vehicle and a vehicle turn signal activation.

35. The vehicle safety system of claim 19, wherein, in response to detecting a potentially hazardous operating condition of the vehicle, the processing unit records driver point grading system information in logical association with still images or video recorded by the one or more cameras.

36. A vehicle safety system for use in a vehicle, the vehicle safety system comprising a processing unit configured to detect vehicular events of interest based on processing vehicle sensor signals and, in response thereto, activate recording by one or more cameras mounted on the vehicle.

37. The vehicle safety system of claim 36, further comprising a number of proximity-type and distance-type object detection sensors for providing object detection signals to the processing unit as vehicle sensor signals, and a vehicle sensor interface included in or associated with the processing unit.

38. The vehicle safety system of claim 36, further comprising a number of cameras for mounting on the vehicle, and a camera interface included in or associated with the processing unit.

39. The vehicle safety system of claim 36, further comprising one or more storage elements for retaining still images or video recorded by the one or more cameras.

40. The vehicle safety system of claim 36, further comprising a communication interface included in or associated with the processing unit, for enabling retrieval of still images or video recorded by the one or more camera by an external system.

41. A vehicle safety system configured for on-board use in a vehicle and comprising:
a processing unit configured to receive sensor signals from one or more forward distance sensors associated with the vehicle, and to operate in first front detection mode in a first speed range and to operate in a second front detection mode in a second speed range below the first speed range;
wherein, in the first and second front detection modes, the processing unit generates driver advisory signals as a function of detected distances between the vehicle a forward object; and
wherein, as an additional feature of the second front detection mode, the processing unit selectively activates vehicle braking responsive to detecting immediately proximate forward objects.

42. The vehicle safety system of claim 41, wherein the processing unit activates recording of still images or video by a front-looking camera on the vehicle responsive to detecting objects within one or more defined distances in the first and second front modes.

43. The vehicle safety system of claim 41, wherein the processing unit is configured to disable its activation of vehicle braking while operating in the second front detection mode in response to user mode control inputs and in response to driver activation of vehicle braking.

44. The vehicle safety system of claim 41, wherein the processing unit is configured to transition automatically between the first and second front detection modes responsive to detecting that qualified vehicle speed is above or below a defined qualified speed threshold.

45. The vehicle safety system of claim 41, wherein, in the first front detection mode, the processing unit is configured to generate driver advisory signals as a function of detected distances between the vehicle and a forward object by:
for a detected forward object falling within a first forward distance range, providing following-too-close advisory signals, including at least one of an audible advisory signal, a visible advisory signal, and a tactile advisory signal and starting a grace period timer; and
upon expiration of the grace period time and if the detected forward object is still too close as determined relative to the first forward distance range, providing one or more supplemental following-too-close advisory signals.

46. The method of claim 45, further comprising assessing driver grading points in a Driver Point Grading System function of the processing unit in response to determining that the detected forward object is still too close upon expiration of the grace period timer.

47. The vehicle safety system of claim 41, wherein, in the second front detection mode, the processing unit is configured to generate driver advisory signals as a function of detected distances between the vehicle and a forward object by:
for a detected forward object falling within a first defined distance, providing proximity advisory signals, including at least one of an audible advisory signal, a visible advisory signal, and a tactile advisory signal;
for a detected forward object falling within a second defined distance, providing a stop advisory signal; and
for a detected forward object detected as being immediately proximate in the forward direction, selectively activating vehicle braking.

48. A vehicle safety system configured for on-board use in a vehicle and comprising:
a processing unit configured to receive sensor signals from one or more forward distance sensors associated with the vehicle, and to operate selectively in a lane change mode and in a lane departure mode;
wherein the processing unit functions in the lane change mode responsive to detecting vehicle turn indicator activation and, in lane change mode, generates driver advisory signals as a function of detecting the presence of objects on a turn-side of the vehicle; and
wherein the processing unit functions in the lane departure mode responsive to detecting lane departure by the vehicle in the absence of a corresponding vehicle turn indicator activation and, in lane departure mode, activates recording by one or more cameras mounted on the vehicle.
